(19) United States
(12) Patent Application Publication
(10) Pub. No.: US 2014/0300640 A1
(43) Pub. Date: Oct. 9, 2014

(54) METHOD AND APPARATUS FOR DETERMINING ORIENTATION RELATIVE TO A USER

(71) Applicant: Gerald P. Kazanjian, Framingham, MA (US)

(72) Inventor: Gerald P. Kazanjian, Framingham, MA (US)

(21) Appl. No.: 13/844,583

(22) Filed: Mar. 15, 2013

(51) Int. Cl. G09G 5/00; G06F 3/041; G06F 3/01

(52) U.S. Cl. CPC G09G 5/00; G06F 3/01; G06F 3/0416; G09G 2340/0492; G06F 2200/1614; G06F 2200/1637
USPC 345/659

(57) ABSTRACT

Example embodiments of the present invention provide a method, an apparatus, and a computer program product for determining orientation of a display presented to a user of a device relative to the user. For example, the method includes receiving a first input indicative of a first orientation of a device and receiving a second input indicative of a second orientation of the device relative to a user of the device. The first input and the second input may be analyzed to determine a change in orientation of the device relative to the user of the device. Orientation of a display presented to the user then may be adjusted according to the determined change in orientation of the device relative to the user.

A portion of the disclosure of this patent document may contain command formats and other computer language listings, all of which are subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This application relates to user interfaces, specifically determining orientation of a display presented to a user relative to the user.

### BACKGROUND

Many portable electronic devices include displays, such as mobile telephones, personal digital assistants (PDAs), laptop computers and tablet computers. Likewise, many of these devices may be held by users in various orientations, including portrait and landscape orientations.

### SUMMARY

Example embodiments of the present invention provide a method, an apparatus, and a computer program product for determining orientation of a display presented to a user of a device relative to the user. For example, the method includes receiving a first input indicative of a first orientation of a device and receiving a second input indicative of a second orientation of the device relative to a user of the device. The first input and the second input may be analyzed to determine a change in orientation of the device relative to the user of the device. Orientation of a display presented to the user then may be adjusted according to the determined change in orientation of the device relative to the user.

### BRIEF DESCRIPTION OF THE DRAWINGS

The above and further advantages of the present invention may be better under stood by referring to the following description taken into conjunction with the accompanying drawings in which:

FIG. 1 is a block diagram illustrating a device, including an orientation controller, according to an example embodiment of the present invention;

FIG. 2 is a diagram illustrating a device held by a user in a portrait orientation at a first time, according to an example embodiment of the present invention;

FIGS. 3-9 are diagrams illustrating a device held by a user in a landscape orientation at a second time, according to respective example embodiments of the present invention;

FIG. 10 is a diagram illustrating a device held by a user in portrait orientation relative to the user and landscape orientation relative to Earth, according to an example embodiment of the present invention;

FIG. 11 is a diagram illustrating a device held by a user in portrait orientation relative to the user and neither landscape nor portrait orientation relative to Earth, according to an example embodiment of the present invention;

FIGS. 12-13 are flow diagrams illustrating methods for determining orientation of a display presented to a user of a device relative to the user, according to example embodiments of the present invention;

FIG. 14 is a flow diagram illustrating a method for determining orientation of a display presented to a user of a device relative to the user according to a first input indicative of a first orientation of a device relative to the user prior to an event relating to the orientation of the device and a second input indicative of a second orientation of the device relative to the user subsequent to the event relating to the orientation of the device, according to an example embodiment of the present invention;

FIG. 15 is a flow diagram illustrating a method for determining orientation of a display presented to a user of a device relative to the user according to a first input indicative of a first orientation of a device relative to Earth subsequent to an event relating to the orientation of the device and a second input indicative of a second orientation of the device relative to the user subsequent to the first input indicative of the first orientation of the device relative to Earth, according to an example embodiment of the present invention;

FIG. 16 is a block diagram illustrating an apparatus, according to an example embodiment of the present invention; and

FIG. 17 is an illustration of an apparatus as embodied in program code, according to an example embodiment of the present invention.

### DETAILED DESCRIPTION

Traditional portable electronic devices determine a proper orientation of a display using an accelerometer. As understood in the art, accelerometers determine the orientation of the device relative to Earth using gravitational forces. Therefore, for example, devices including accelerometers typically display an image rotated so that the bottom of the image is positioned down relative to Earth, according to a determination by the accelerometer. However, it is not the location of down relative to Earth, as determined by the orientation of the device relative to Earth, that should be the deciding factor of what is the proper orientation of the display. Rather, orientation of the display is more properly determined according to the orientation of the device relative to a user of the device.

For example, consider a user while standing or sitting upright holding a device in a first orientation (i.e., a portrait orientation relative to the user). If the user changes position by lying down on the user's side, the display will change orientation because the accelerometer in the device detects a change in orientation of the device relative to Earth (i.e., although the user is still holding the device in a portrait orientation relative to the user, the device is now in a landscape orientation relative to Earth). Therefore, the accelerometer causes the device to rotate the display so that the bottom of the display is positioned down relative to Earth; however, such an orientation actually causes the display to be oriented ninety degrees from what would be the proper orientation for this user lying on the user's side to be able to view the display.

Similarly, if the user is reclining or lying down on the user's back and, rather than changing position, rotates the device from the first orientation (i.e., the portrait orientation) to a second orientation (i.e., a landscape orientation relative to the user), the display will not change orientation at all because the accelerometer in the device detects no change in orientation of the device relative to Earth (i.e., although the user is now holding the device in a landscape orientation relative to the user, the device is still in a horizontal plane relative to Earth). Therefore, the accelerometer causes the device to fail to rotate the display so that the bottom of the display is positioned to the side relative to Earth, and such an orientation causes the display to be oriented ninety degrees from what would be the proper orientation for this user lying on the user's back to be able to view the display.

Accordingly, example embodiments of the present invention overcome these and other problems by providing a method, an apparatus, and a computer program product for determining orientation of a display presented to a user of a device relative to the user.

An example method for determining rotation of an image displayed on a portable electronic device includes receiving a first input indicating a first orientation of the portable electronic device and receiving a second input indicating a second orientation of the portable electronic device. The first input and the second input are then analyzed to determine a change in orientation of the portable electronic device relative to a user of the portable electronic device. Then, according to the determined change in orientation of the portable electronic device relative to the user of the portable electronic device, the image displayed on the portable electronic device is rotated.

In one embodiment, the first input indicating the first orientation of the portable electronic device may be a first image of the user of the portable electronic device captured by a front facing camera of the portable electronic device. In this embodiment, the first input indicates a first orientation of the portable electronic device relative to the user of the portable electronic device. Likewise, the second input indicating the second orientation of the portable electronic device may be a second image of the user of the portable electronic device captured by the front facing camera of the portable electronic device. The first and second images of the user of the portable electronic device may be examined to determine the first and second orientations of the portable electronic device, respectively. For example, the first image may show the user of the portable electronic device in a portrait orientation and the second image may show the user of the portable electronic device in a landscape orientation. These orientations indicate orientations of the portable electronic device relative to the user of the portable electronic device and may be compared to determine a change in orientation of the portable electronic device relative to the user of the portable electronic device, here indicating that the portable electronic device has been rotated from a portrait orientation to a landscape orientation relative to the user of the portable electronic device. However, in other example embodiments, other changes in orientation may be determined, including ninety degrees clockwise, ninety degrees counter-clockwise, one hundred eighty degree rotation (i.e., flip) and no rotation.

Thus, according to the determined change in orientation of the portable electronic device relative to the user of the portable electronic device, the image displayed on the portable electronic device may be rotated to display the image positioned for normal viewing by the user of the portable electronic device (i.e., natural, not requiring tilting of the user's head) if comparing the first orientation of the portable electronic device relative to the user of the portable electronic device and the second orientation of the portable electronic device relative to the user of the portable electronic device determines a change in orientation of the portable electronic device relative to the user of the portable electronic device. Likewise, if comparing the first orientation of the portable electronic device relative to the user of the portable electronic device and the second orientation of the portable electronic device relative to the user of the portable electronic device determines no change in orientation of the portable electronic device relative to the user of the portable electronic device, display of the image on the portable electronic device may be maintained to continue display of the image positioned for normal viewing by the user of the portable electronic device.

In another embodiment, the first input indicating the first orientation of the portable electronic device may be an output from an accelerometer of the portable electronic device. In this embodiment, the first input indicates an orientation of the portable electronic device relative to Earth. The second input indicating the second orientation of the portable electronic device may be an image of the user of the portable electronic device captured by a front facing camera of the portable electronic device. In this embodiment, the second input indicates an orientation of the portable electronic device relative to the user of the portable electronic device. The output of the accelerometer and the image of the user of the portable electronic device may be examined to determine the first and second orientations of the portable electronic device, respectively. For example, the output from the accelerometer may indicate a rotation of the portable electronic device from a portrait orientation relative to Earth to a landscape orientation relative to Earth and the image may show the user of the portable electronic device in a portrait orientation. These orientations may be compared to determine a change in orientation of the portable electronic device relative to the user of the portable electronic device—here indicating that, although the portable electronic device has changed orientation relative to Earth (i.e., from portrait to landscape), there has been no change in orientation of the portable electronic device relative to the user of the portable electronic device, as would happen if the user of the portable electronic device reclined or laid down. Likewise, the output from the accelerometer may indicate a rotation of the portable electronic device from a portrait orientation relative to Earth to a landscape orientation relative to Earth and the image may show the user of the portable electronic device in a landscape orientation. These orientations, too, may be compared to determine a change in orientation of the portable electronic device relative to the user of the portable electronic device - here indicating that the portable electronic device has changed orientation relative to the user, as indicated by the change in orientation relative to the Earth determined by the accelerometer and confirmed by the change in orientation relative to the user of the portable electronic device by the image.

Thus, according to the determined change in orientation of the portable electronic device relative to the user of the portable electronic device, the image displayed on the portable electronic device may be rotated to display the image positioned for normal viewing by the user of the portable electronic device (i.e., natural, not requiring tilting of the user's head) if comparing the orientation of the portable electronic device relative to the Earth and the orientation of the portable electronic device relative to the user of the portable electronic device determines a change in orientation of the portable electronic device relative to the user of the portable electronic device. Likewise, if comparing the orientation of the portable electronic device relative to the Earth and the orientation of the portable electronic device relative to the user of the portable electronic device determines no change in orientation of the portable electronic device relative to the user of the portable electronic device, display of the image on the portable electronic device may be maintained to continue display of the image positioned for normal viewing by the user of the portable electronic device.

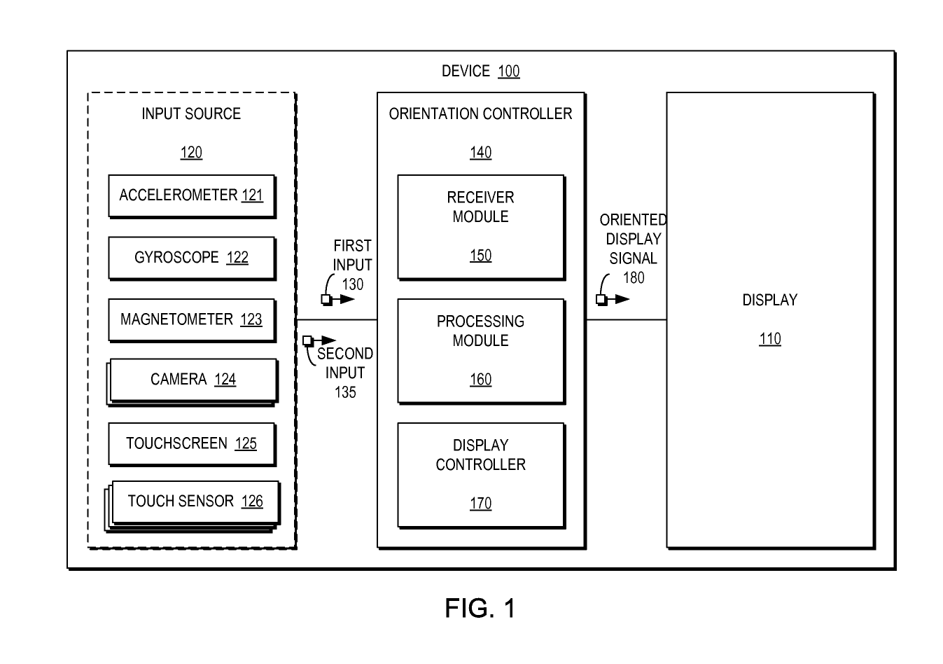

FIG. 1 is a block diagram illustrating a device 100, including an orientation controller 140, according to an example embodiment of the present invention. As illustrated in FIG. 1, the orientation controller 140 may include a receiver module 150, a processing module 160, and a display controller 170. The receiver module 150 may be configured to receive a first input 130 indicating a first orientation of the device 100 and receive a second input 135 indicating a second orientation of the device 100. The processing module then may analyze the first input 130 and the second input 135 to determine a change in orientation of the device 100 relative to a user of the device (not shown). The display controller 170 then may adjust orientation of a display 110 presented to the user of the device 100 according to the determined change in orientation of the device 100 relative to the user, such as via a oriented display signal 180.

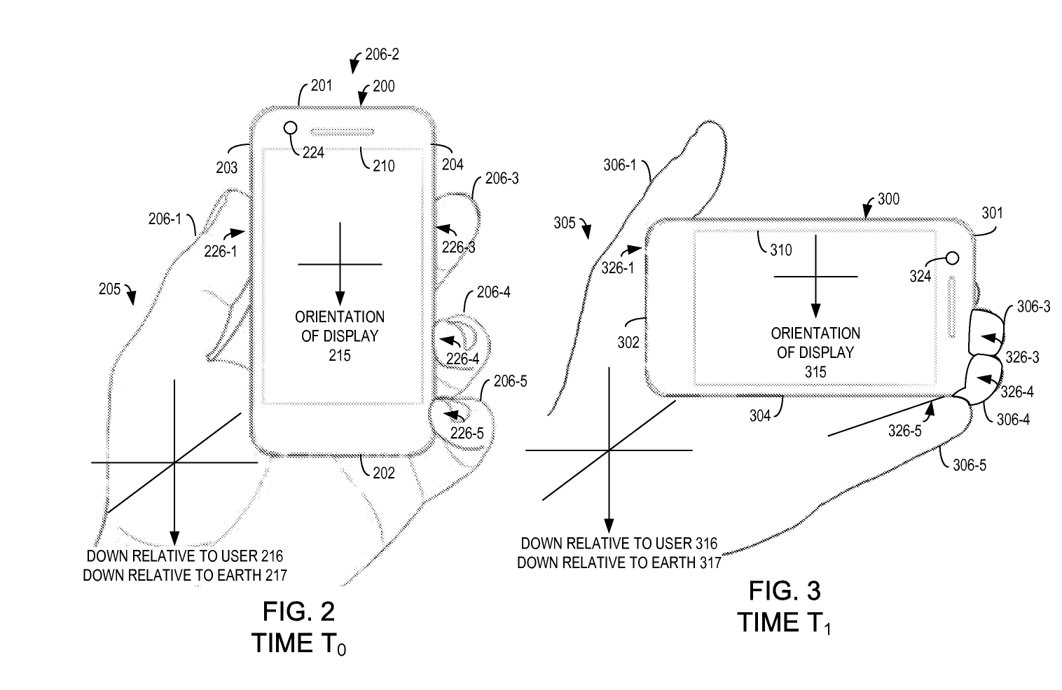

As illustrated in FIG. 1, a plurality of input sources 120 may provide the first input 130 and the second input 135. For example, the input sources 120 may include an accelerometer 121, a gyroscope 122, a magnetometer 123, one or more cameras 124 (e.g., a front facing camera and a rear facing camera), a touchscreen 125, and one or more touch sensors 126. As will be described in greater detail below with respect to FIGS. 2-9, the touch sensors 126 may be dispersed around the perimeter of the device 100 and on the back of the device.

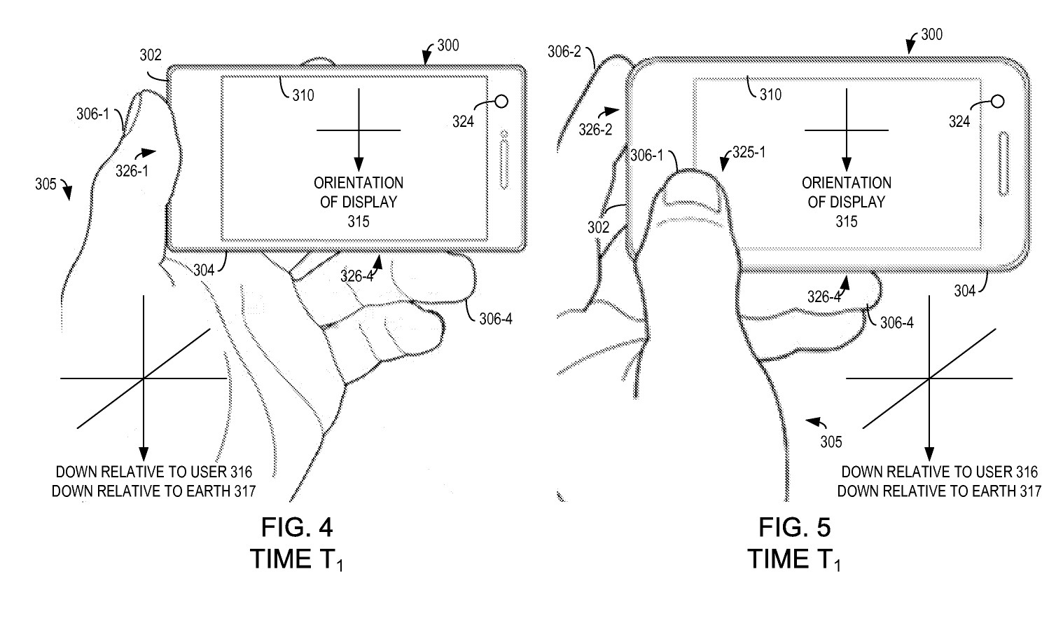

FIG. 2 is a diagram illustrating a device 200 held by a user 205 in a portrait orientation at a first time, according to an example embodiment of the present invention. As illustrated in FIG. 2, the device 200 includes a display 210, with the orientation of the display 215 oriented down relative to both the user 216 and Earth 217, and a front facing camera 224 that faces the user 205. The device 200 may be held by the user 205 in the portrait orientation as shown or, as will be described below with reference to FIGS. 3-9, may be held in a landscape orientation.

One or more accelerometers included in the portable electronic device (generally referred to as the accelerometer) (not shown) or a gyroscope (not shown), typically not viewable from the outside, may be provided for determining an orientation of the device 200, such as portrait and landscape, as understood in the art. Here, the accelerometer senses the direction from which it experiences gravitational forces to determine the direction of “down” from the device 200 relative to Earth. For a user 205 standing or sitting upright, down relative to Earth 217 is also down relative to the user 216.

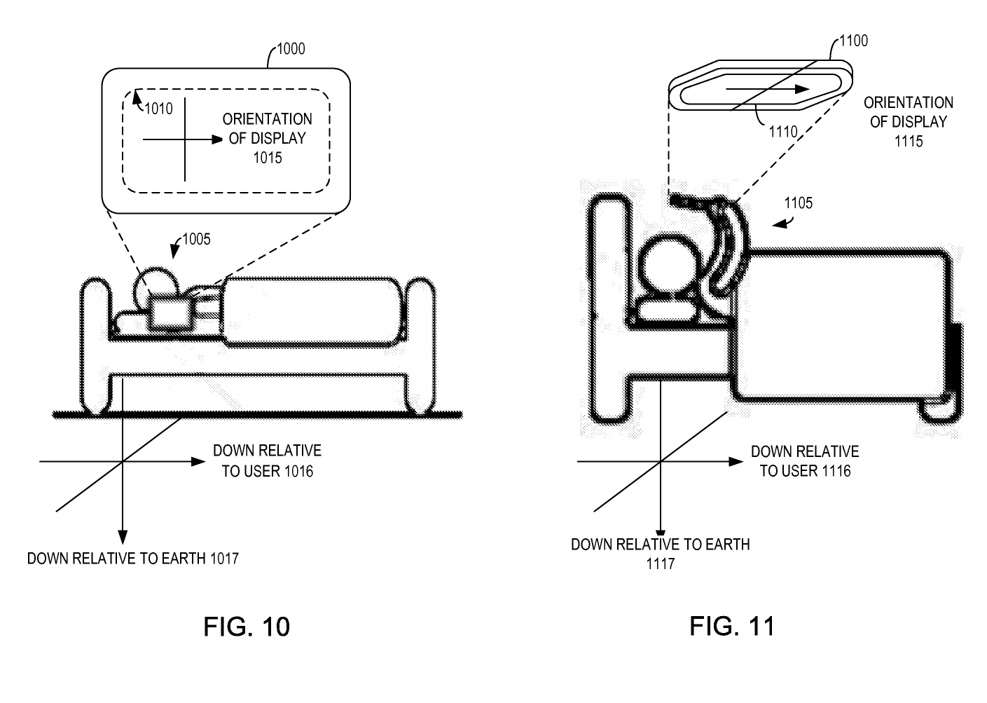

FIGS. 3-9 are diagrams illustrating a device 300 held by a user 305 in a landscape orientation, according to example embodiments of the present invention, which, together with FIG. 1, may be studied in conjunction with FIGS. 12-13 which are flow diagrams illustrating methods for determining orientation of a display presented to a user of a device relative to the user according to example embodiments of the present invention. As illustrated in FIGS. 3-9, the device 300 may be held by a user 305 in a landscape orientation, such as after the user 305 rotates the device 300 from the portrait orientation as illustrated in FIG. 2. The rotation of the device 300 from time t₀ to t₁ will be sensed by the accelerometer (not shown), which will cause the portable electronic device 100 to attempt to rotate the image shown on the display 310 to an orientation so that “down” on the display 310 is consistent with “down” relative to 317 Earth as understood in the art.

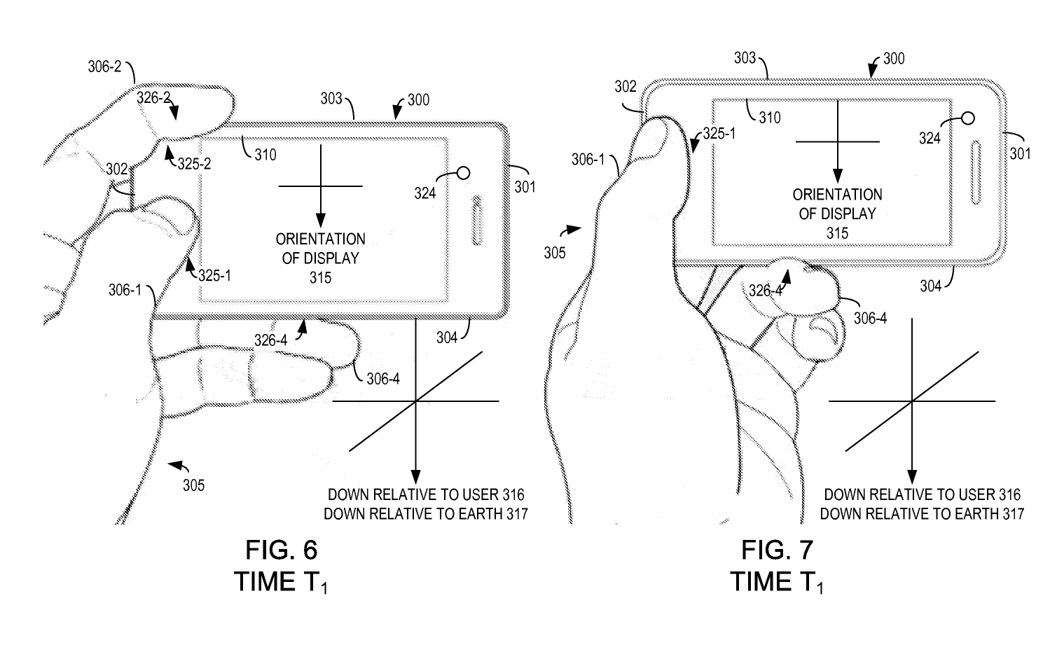

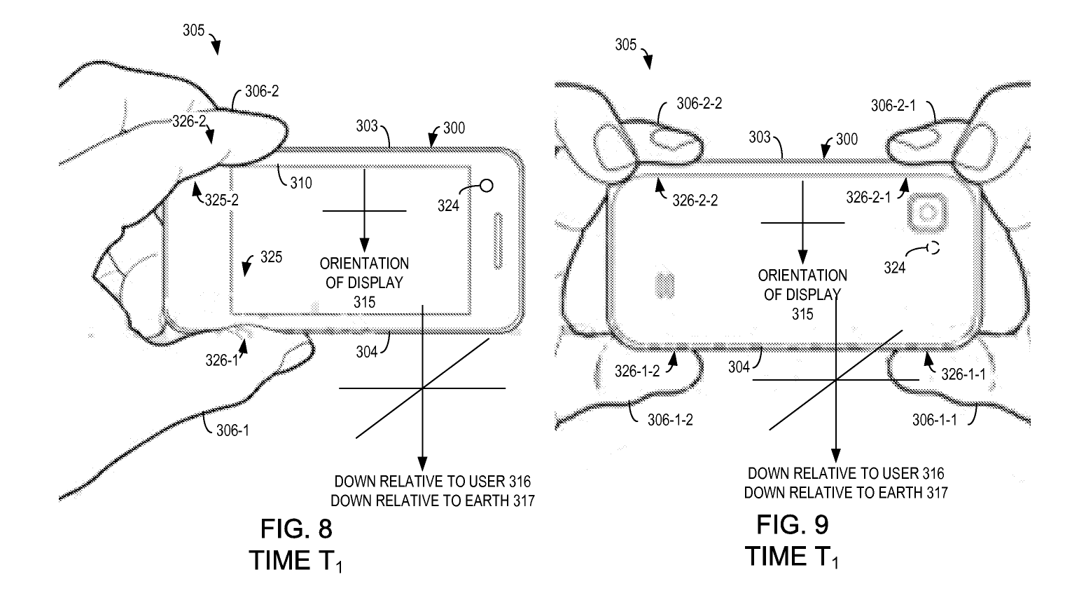

Accordingly, the receiver module 150 may receive a first input 130 indicative of a first orientation of the device 300 (i.e., transitioning to landscape orientation from time t₀ to t₁) (1205). Again, for a user 305 standing or sitting upright, down relative to Earth 317 is also down relative to the user 316. However, while accelerometers may be adequate for a traditional device at times when the device is held by a user standing or sitting upright, accelerometers fail when users are in other positions, such as lying in bed on the user's side or reclined or lying in bed on the user's back. Such shortcomings will be described below with reference to FIGS. 10-11, respectively.

The receiver module 150 then may receive a second input indicative of a second orientation of the device 300 relative to the user 305 (1210). For example, as illustrated in FIGS. 3-9, the receiver module 150 may receive an image from the front facing camera 324 and perform a recognition on user facial features to determine an orientation of the device 300 relative to the user 305.

In other embodiments, the receiver module 150 may receive touch signals from one or more touch sensors 326-1-326-5 (generally 326) generated by the user's fingers 306-1-306-5 (generally 306) contacting the sensors 326 on respective sides 301, 302, 303, 304 of the device 300. According to a determination of which touch sensors 326 are sending touch signals, the processing module 160 may determine an orientation of the device 300 relative to the user 305. It should be understood that it would be extremely unlikely that touch signals would be received in the configurations of FIGS. 3-9 for a device 300 held in a portrait orientation.

As illustrated in FIG. 3, the receiver module 150 may receive touch signals from touch sensors 326-1, 326-3, 326-4, 326-5 on the top 301, bottom 302, and right side 304 of the device 300, respectively. As illustrated in FIG. 4, the receiver module 150 may receive touch signals 326-2, 326-4 from touch sensors on the bottom 302 and right side 304 of the device 300, respectively.

As illustrated in FIG. 5, the receiver module 150 may receive touch signals 326-5, 326-4 from touch sensors on the bottom 302 and right side 304 of the device, respectively. Additionally, the receiver module 150 may receive a touchscreen signal 325-1. Similarly, as illustrated in FIG. 6, the receiver module 150 may receive touch signals 326-1, 326-4 from touch sensors on the bottom 302 and right side 304 of the device 300. Likewise, as illustrated in FIG. 7, the receiver module 150 may receive touch signals 326-2. 326-4 from touch sensors on the bottom 302 and right side 304 of the device 300, as well as a touchscreen signal 325-1.

As illustrated in FIG. 8, the receiver module 150 may receive touch signals 326-1, 326-2 from touch sensors on the left side 303 and right side 304 of the device 300. Similarly, as illustrated in FIG. 9, the receiver module 150 may receive touch signals 326-1-1, 326-2-1. 326-1-2, 326-2-2 from touch sensors on the left side 303 and right side 304 of the device 300.

Returning to FIG. 1, the processing module 160 then may analyze the first input and the second input to determine a change in orientation of the device relative to the user of the device (1215). For example, as illustrated in FIG. 13, the processing module 160 may determine the first orientation of the device 300 from the first input 130 (1220). Here, with reference to FIGS. 3-9, the processing module 160 would determine that the first input from the accelerometer indicated a change in orientation of the device 300 to a landscape orientation with the orientation of the display 315 aligned with down relative to Earth 317.

The processing module 160 then may determine a second orientation of the device 300 relative to the user 305 from the second input 135 (1225). Here, with reference to FIGS. 3-9, the processing module 160 may determine the second orientation of the device 300 relative to the user 305 from one or more of the front facing camera 324, the touchscreen 325, and the touch sensors 326.

To compare the first orientation of the device 300 as determined from the accelerometer (1220) with the second orientation of the device 300 relative to the user 305 as determined from the front facing camera 324, the touchscreen 325, and the touch sensors 326 (1330) the processing module 160 may compare the orientations. For example, as illustrated in FIGS. 3-9, the first input from the accelerometer would indicate that the orientation of the display 315 should align with down relative to earth 317. The second input indicative of an orientation with respect to the user 305 would indicate that the device 300 is in a landscape orientation and that down relative to the user 316 aligns with down relative to earth 317. Accordingly, the processing module 160 determines the change in orientation of the device 300 relative to the user 305 according to the differences between the first orientation of the device 300 (e.g., relative to earth) and the second orientation of the device 300 relative to the user 305 (1335).

Returning to FIG. 1, the display controller 170 then may adjust orientation of the display 110 presented to the user according to the determined change in orientation of the device 300 relative to the user 305 (1240).

FIG. 10 is a diagram illustrating a device 1000 held by a user 1005 in portrait orientation relative to the user 1016 and landscape orientation relative to Earth 1017. As illustrated in FIG. 10, the user 1005 is lying on the user's side. Traditionally, as discussed above, orientation of the device 1000 to a landscape orientation relative to Earth may be sensed by an accelerometer (not shown), which may cause the device 1000 to rotate the display 1010 to an orientation so that “down” on the display is consistent with “down” relative to Earth 1017 as understood in the art. However, as discussed above, this causes the image shown on the display 1010 to be in an orientation not for normal viewing (i.e., as illustrated, the image shown on the display 1010 would be in an orientation rotated ninety degrees from an expected orientation for regular viewing by the user 1005). In this example, rotation of the display 1010 would be unnecessary because the orientation of the device 1000 relative to the user 1016 has not changed; only the orientation of the device 1000 relative to Earth 1017 has changed (as determined by the accelerometer). However, as described above, a conventional device 1000, and its accelerometer, have no way to make a determination whether rotation of the display 1010 is necessary.

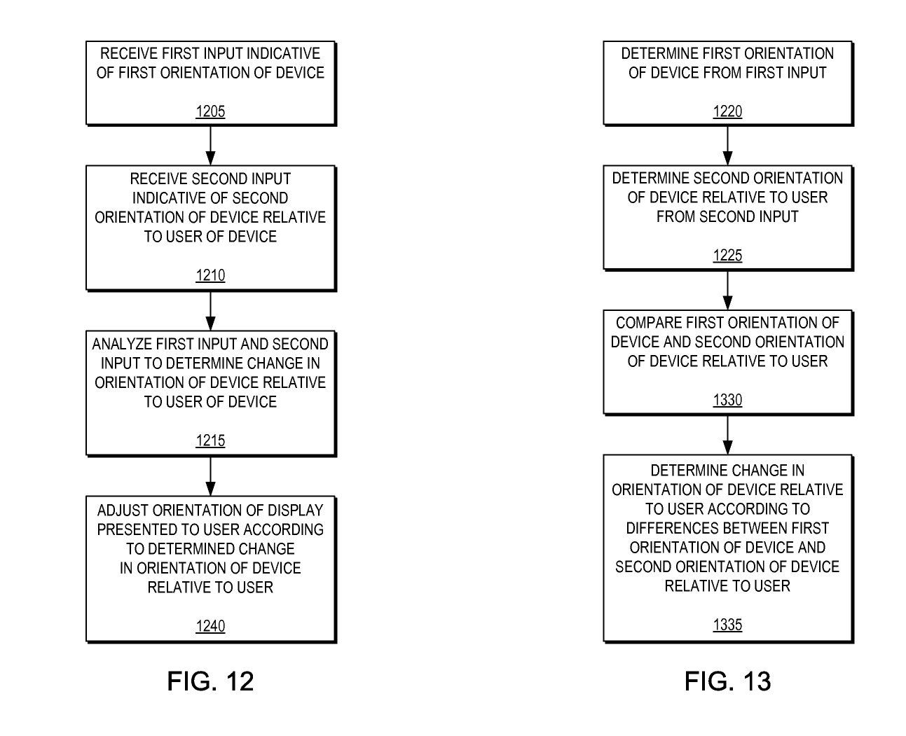

FIG. 10 may be studied in conjunction with FIG. 14 which is a flow diagram illustrating a method for determining orientation of a display presented to a user of a device relative to the user according to a first input indicative of a first orientation of a device relative to Earth subsequent to an event relating to the orientation of the device and a second input indicative of a second orientation of the device relative to the user subsequent to the first input indicative of the first orientation of the device relative to Earth according to an example embodiment of the present invention. As illustrated in FIGS. 1, 10, and 14, the receiver module 150 may receive a first input (e.g., from the accelerometer) 130 indicative of a first orientation of the device 1000 relative to Earth subsequent to an event relating to the orientation of the device (i.e., that the device 1000 is in a landscape orientation relative to Earth 1017 after it is rotated from a portrait orientation) (1405). The receiver module 150 then may receive a second input 135 indicative of a second orientation of the device 1000 relative to a user 1005 of the device 1000 (e.g., as described with reference to FIGS. 3-9) subsequent to the first input 130 (1410).

The processing module 160 determines the first orientation of the device 1000 relative to Earth from the first input 130 (i.e., that the device 1000 is in a landscape orientation relative to Earth 1017) (1420) and determines the second orientation of the device 1000 relative to the user 1005 from the second input 135 (i.e., that the device 1000 is in portrait orientation relative to the user 1016) (1425). The processing module 160 then may compare the first orientation of the device 1000 and the second orientation of the device 1000 relative to the user 1005 to determine differences between the first orientation of the device 1000 and the second orientation of the device 1000 relative to the user 1005 (i.e., that the device 1000 has not changed orientation relative to the user 1016 despite the change in orientation relative to Earth 1017) (1430).

The processing module 160 then may determine whether the differences are indicative of a change in orientation of the device 1000 relative to the user 1005 associated with event relating to orientation of the device 1000 (i.e., changing orientation relative to Earth 1017) (1435). Therefore, the processing module 160 may determine that, despite the first input 130 indicating that the orientation of the display 1015 should be adjust to down relative to Earth 1017, the second input 135 confirms that the orientation of the display 1015 need not (1437) be adjusted and that the orientation of the display 1015 should be maintained down relative to the user 1016 (1440). In other embodiments, if the differences are indicative of a change in orientation of the device 1000 relative to the user 1005 (1438), then the display controller 170 may adjust orientation of the display presented to the user according to the determined change in orientation of the device relative to the user (1450), such as via an oriented display signal 180 to the display 110.

FIG. 11 is a diagram illustrating a device 1100 held by a user 1105 in portrait orientation relative to the user 1116 and neither landscape nor portrait orientation relative to Earth 1117. As illustrated in FIG. 11, the user 1105 may be lying on the user's back. Orientation of the device 1100 to a landscape orientation relative to the user 1105 is not sensed by the accelerometer (not shown) because there is no change in orientation of the device 1100 relative to Earth 1117 for the accelerometer to sense. For example, a change in orientation of the device 1100 from portrait to landscape, and vice versa, occurs around the Y axis relative to the user 1105 lying down.

However, an accelerometer included in the device 1100 to sense the direction from which it experiences gravitational forces is configured to sense changes in orientation of the device 1100 around the Z axis relative to the portable electronic device 1100 (i.e., configured to determine the direction of the Y axis relative to the device 1100). Therefore, although rotation in the example illustrated in FIG. 11 is around the Z axis relative to the device 1100, the Z axis relative to the device 1100 is aligned with the direction from which the accelerometer would experience gravitational forces (i.e., down relative to Earth 1117). Thus, the accelerometer would not sense a change in direction from which it experiences gravitational forces and would not determine a new direction of “down” relative to the user 1116. In this example, rotation of the display 1110 would not occur when the device 1100 is held by a user 1105 while lying on the user's back because the conventional portable electronic device 1100, and its accelerometer, have no way to detect a change in orientation of the device 1100 around an axis aligned with the direction of gravitational forces experienced by the portable electronic device 1100.

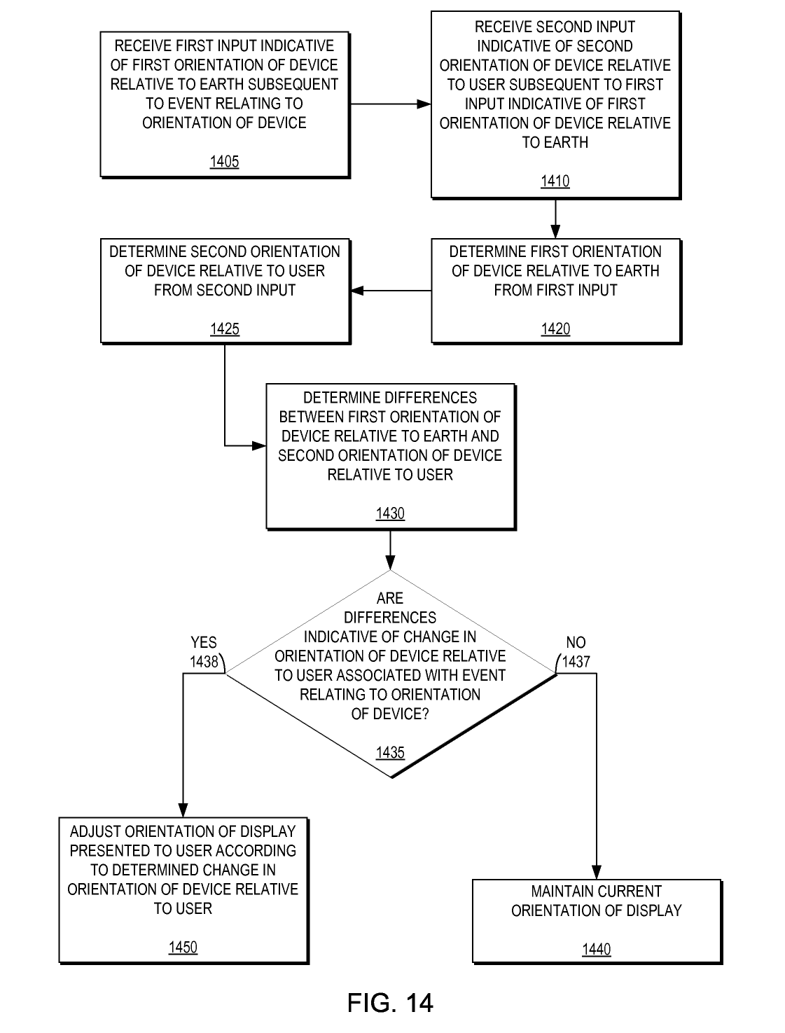

FIG. 11 may be studied in conjunction with FIG. 15 which is a flow diagram illustrating a method for determining orientation of a display presented to a user of a device relative to the user according to a first input indicative of a first orientation of a device relative to the user prior to an event relating to the orientation of the device and a second input indicative of a second orientation of the device relative to the user subsequent to the event relating to the orientation of the device according to an example embodiment of the present invention. As illustrated in FIGS. 1, 10, and 15, the receiver module 150 may receive a first input 130 indicative of a first orientation of the device 1000 relative to the user 1105 prior to an event relating to orientation of the device 1100 (i.e., that the device 1100 is in a portrait orientation relative to the user 1105 before being rotated to landscape orientation relative to the user 1105) (1505). The receiver module 150 then may receive a second input 135 indicative of a second orientation of the device 1100 relative to a user 1105 subsequent to the event relating to orientation of the device 1100 (i.e., that the device 1100 is in a landscape orientation relative to the user 1105) (e.g., as described with reference to FIGS. 3-9) (1510).

The processing module 160 determines the first orientation of the device 1100 relative to the user 1105 from the first input 130 (i.e., that the device 1100 was in a portrait orientation relative to the user 1116) (1520) and determines the second orientation of the device 1100 relative to the user 1105 from the second input 135 (i.e., that the device 1100 is in a landscape orientation relative to the user 1116) (5425). The processing module 160 then may compare the first orientation of the device 1100 relative to the user 1105 and the second orientation of the device 1100 relative to the user 1105 to determine differences between the first orientation of the device 1100 relative to the user 1105 and the second orientation of the device 1100 relative to the user 1105 (i.e., that the device 1100 has changed orientation relative to the user 1116 despite no detection of a change in orientation relative to Earth 1117) (1530).

The processing module 160 then may determine whether the differences are indicative of a change in orientation of the device 1100 relative to the user 1105 associated with event relating to orientation of the device 1100 (i.e., changing orientation relative to the user 1016) (1535). Therefore, the processing module 160 may determine that, the first and second inputs 130, 135 confirms that the orientation of the display 1115 needs (1538) to be adjusted and the display controller 170 may adjust orientation of the display presented to the user according to the determined change in orientation of the device relative to the user (1550), such as via an oriented display signal 180 to the display 110. In other embodiments, if the differences are not indicative of a change in orientation of the device 1100 relative to the user 1105 (1537), then the current orientation of the display may be maintained (1540).

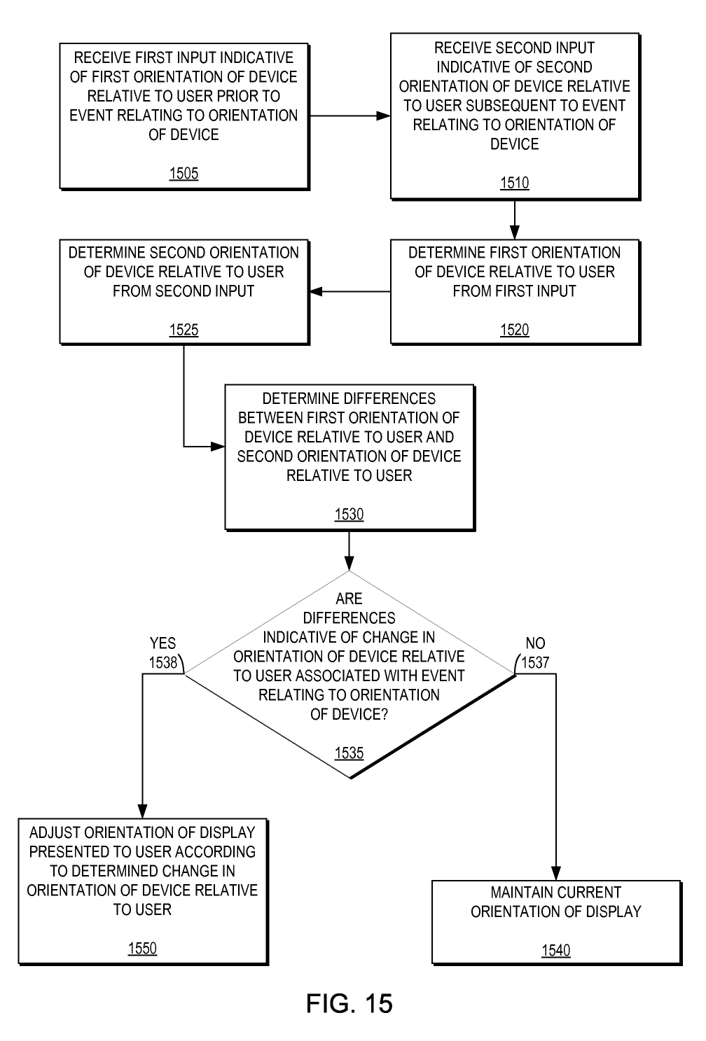

FIG. 16 is a block diagram of an example embodiment apparatus 1605 according to the present invention. The apparatus 1605 may be part of a system 1600 and includes memory 1610 storing program logic 1615, a processor 1620 for executing a process 1625, and a communications I/O interface 1630, connected via a bus 1635.

The methods and apparatus of this invention may take the form, at least partially, of program code (i.e., instructions) embodied in tangible non-transitory media, such as floppy diskettes, CD-ROMs, hard drives, random access or read only-memory, or any other machine-readable storage medium. When the program code is loaded into and executed by a machine, such as the computer of FIG. 16, the machine becomes an apparatus for practicing the invention. When implemented on one or more general-purpose processors, the program code combines with such a processor to provide a unique apparatus that operates analogously to specific logic circuits. As such, a general purpose digital machine can be transformed into a special purpose digital machine.

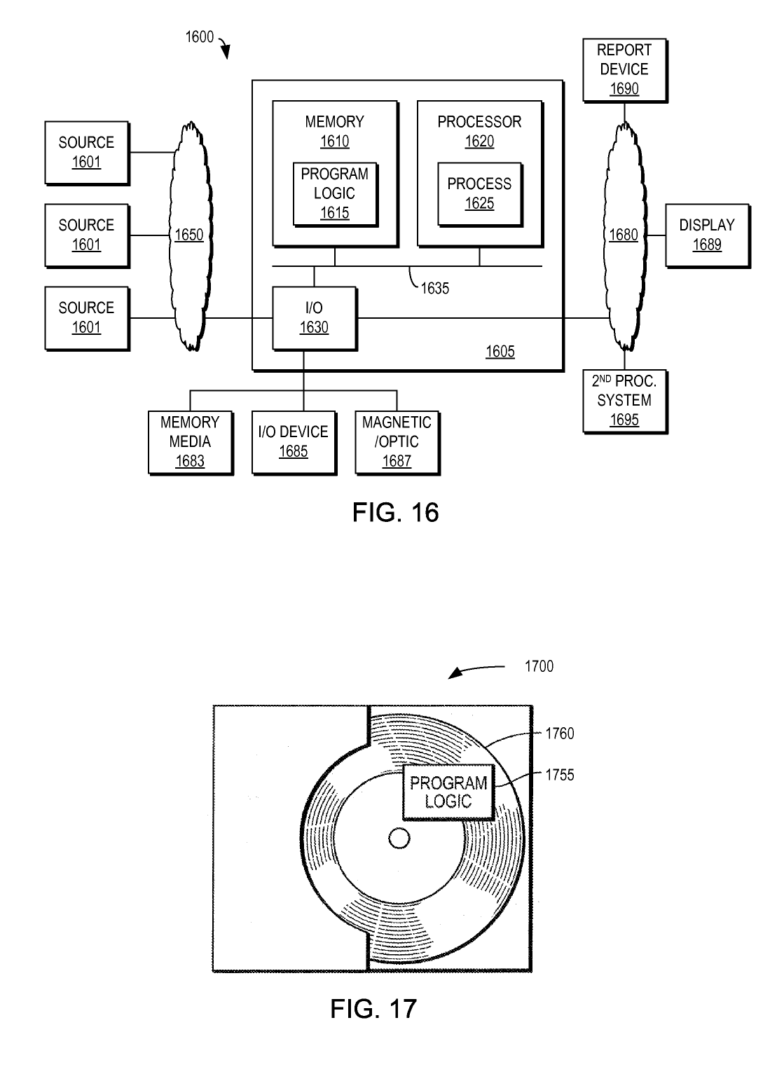

FIG. 17 shows program logic 1755 embodied on a computer-readable medium 1760 as shown, and wherein the logic 1755 is encoded in computer-executable code configured for carrying out the gas controlling process of this invention, thereby forming a computer program product 1700.

The logic for carrying out the method may be embodied as part of the aforementioned system, which is useful for carrying out a method described with reference to embodiments shown in, for example, FIGS. 1-15. For purposes of illustrating the present invention, the invention is described as embodied in a specific configuration and using special logical arrangements, but one skilled in the art will appreciate that the device is not limited to the specific configuration but rather only by the claims included with this specification.

Embodiments of the present invention have been described herein with reference to exemplary computing systems and data storage systems and associated servers, computers, storage units and devices and other processing devices. It is to be appreciated, however, that embodiments of the invention are not restricted to use with the particular illustrative system and device configurations shown.

Although the foregoing invention has been described in some detail for purposes of clarity of understanding, it will be apparent that certain changes and modifications may be practiced within the scope of the appended claims. Accordingly, the present implementations are to be considered as illustrative and not restrictive, and the invention is not to be limited to the details given herein, but may be modified within the scope and equivalents of the appended claims.

What is claimed is:

1. A method comprising:
receiving a first input indicative of a first orientation of a device;
receiving a second input indicative of a second orientation of the device relative to a user of the device;
analyzing the first input and the second input to determine a change in orientation of the device relative to the user of the device; and
adjusting orientation of a display presented to the user according to the determined change in orientation of the device relative to the user.

2. The method of claim 1 wherein analyzing the first input and the second input to determine a change in orientation of the device relative to the user of the device comprises:
determining a first orientation of the device from the first input;
determining a second orientation of the device relative to the user from the second input;
comparing the first orientation of the device and the second orientation of the device relative to the user to determine differences between the first orientation of the device and the second orientation of the device relative to the user; and
determining the change in orientation of the device relative to the user according to the differences between the first orientation of the device and the second orientation of the device relative to the user.

3. The method of claim 2
wherein receiving a first input indicative of a first orientation of a device comprises receiving a first input indicative of a first orientation of the device relative to the user prior to an event relating to the orientation of the device;
wherein receiving a second input indicative of a second orientation of the device relative to a user of the device comprises receiving a second input indicative of a second orientation of the device relative to the user subsequent to the event relating to the orientation of the device; and
wherein determining the change in orientation of the device relative to the user according to the differences between the first orientation of the device and the second orientation of the device relative to the user comprises determining whether a difference between the first orientation of the device relative to the user and the second orientation of the device relative to the user is indicative of a change in orientation of the device relative to the user associated with the event relating to the orientation of the device.

4. The method of claim 2
wherein receiving a first input indicative of a first orientation of a device comprises receiving a first input indicative of a first orientation of the device relative to Earth subsequent to an event relating to the orientation of the device;
wherein receiving a second input indicative of a second orientation of the device relative to a user of the device comprises receiving a second input indicative of a second orientation of the device relative to the user subsequent to the first input indicative of the first orientation of the device relative to Earth; and
wherein determining the change in orientation of the device relative to the user according to the differences between the first orientation of the device and the second orientation of the device relative to the user comprises determining whether a difference between the first orientation of the device relative to Earth and the second orientation of the device relative to the user is indicative of a change in orientation of the device relative to the user associated with the event relating to the orientation of the device.

5. The method of claim 2 wherein receiving a second input indicative of a second orientation of the device relative to a user of the device comprises receiving an image indicative of the second orientation of the device relative to the user.

6. The method of claim 5
wherein determining a second orientation of the device relative to the user from the second input comprises determining an orientation of one or more facial features of the user according to the image; and
wherein comparing the first orientation of the device and the second orientation of the device relative to the user comprises comparing the first orientation of the device and the orientation of the one or more facial features of the user to determine the change in orientation of the device relative to the user of the device.

7. The method of claim 6
wherein comparing the first orientation of the device and the orientation of the one or more facial features of the user to determine the change in orientation of the device relative to the user of the device comprises determining whether the orientation of facial features of the user is indicative of a change in orientation of the device relative to the user of the device; and
wherein adjusting orientation of a display presented to the user according to the determined change in orientation of the device relative to the user comprises adjusting orientation of the display according to the determination of whether the orientation of facial features of the user is indicative of a change in orientation of the device relative to the user of the device to properly present the display to the user.

8. The method of claim 2 wherein receiving a second input indicating a second orientation of the device relative to a user of the device comprises receiving a touch signal indicative of the second orientation of the device relative to the user.

9. The method of claim 8
wherein determining a second orientation of the device relative to the user from the second input comprises determining an orientation of user digits according to the touch signal; and
wherein comparing the first orientation of the device and the second orientation of the device relative to the user comprises comparing the first orientation of the device and the orientation of user digits to determine the change in orientation of the device relative to the user of the device.

10. The method of claim 9
wherein comparing the first orientation of the device and the orientation of the one or more facial features of the user to determine the change in orientation of the device relative to the user of the device comprises determining whether the orientation of user digits is indicative of a change in orientation of the device relative to the user of the device; and
wherein adjusting orientation of a display presented to the user according to the determined change in orientation of the device relative to the user comprises adjusting orientation of the display according to the determination of whether the orientation of user digits is indicative of a change in orientation of the device relative to the user of the device to properly present the display to the user.

11. An apparatus comprising:
a receiver module configure to receive a first input indicative of a first orientation of a device and receive a second input indicative of a second orientation of the device relative to a user of the device;
a processing module configured to analyze the first input and the second input to determine a change in orientation of the device relative to the user of the device; and
a display controller configured to adjust orientation of a display presented to the user according to the determined change in orientation of the device relative to the user.

12. The apparatus of claim 11 wherein the processing module is further configured to determine a first orientation of the device from the first input, determine a second orientation of the device relative to the user from the second input, compare the first orientation of the device and the second orientation of the device relative to the user to determine differences between the first orientation of the device and the second orientation of the device relative to the user, and determine the change in orientation of the device relative to the user according to the differences between the first orientation of the device and the second orientation of the device relative to the user.

13. The apparatus of claim 12
wherein the receiver module is further configured to receive a first input indicative of a first orientation of the device relative to the user prior to an event relating to the orientation of the device and receive a second input indicative of a second orientation of the device relative to the user subsequent to the event relating to the orientation of the device; and
wherein the processing module is further configured to determine whether a difference between the first orientation of the device relative to the user and the second orientation of the device relative to the user is indicative of a change in orientation of the device relative to the user associated with the event relating to the orientation of the device.

14. The apparatus of claim 12
wherein the receiving module is further configured to receive a first input indicative of a first orientation of the device relative to Earth subsequent to an event relating to the orientation of the device and receive a second input indicative of a second orientation of the device relative to the user subsequent to the first input indicative of the first orientation of the device relative to Earth; and
wherein the processing module is further configured to determine whether a difference between the first orientation of the device relative to Earth and the second orientation of the device relative to the user is indicative of a change in orientation of the device relative to the user associated with the event relating to the orientation of the device.

15. The apparatus of claim 2
wherein the receiver module is further configured to receive an image indicative of the second orientation of the device relative to the user; and
wherein the processing module is further configured to determine an orientation of one or more facial features of the user according to the image and compare the first orientation of the device and the orientation of the one or more facial features of the user to determine the change in orientation of the device relative to the user of the device.

16. The apparatus of claim 15
wherein the processing module is further configured to determine whether the orientation of facial features of the user is indicative of a change in orientation of the device relative to the user of the device; and
wherein the display controller is further configured to adjust orientation of the display according to the determination of whether the orientation of facial features of the user is indicative of a change in orientation of the device relative to the user of the device to properly present the display to the user.

17. The apparatus of claim 2
wherein the receiver module is further configured to receive a touch signal indicative of the second orientation of the device relative to the user; and
wherein the processing module is further configured to determine determining an orientation of user digits according to the touch signal and compare the first orientation of the device and the orientation of user digits to determine the change in orientation of the device relative to the user of the device.

18. The apparatus of claim 17
wherein the processing module is further configured to determine whether the orientation of user digits is indicative of a change in orientation of the device relative to the user of the device; and
wherein the display controller is further configured to adjust orientation of the display according to the determination of whether the orientation of user digits is indicative of a change in orientation of the device relative to the user of the device to properly present the display to the user.

19. A computer program product comprising a non-transitory computer readable storage medium encoded with computer programming logic that, when executed on a processor, determines orientation of a display presented to a user relative to the user, the computer program product comprising:
computer program code for receiving a first input indicative of a first orientation of a device;
computer program code for receiving a second input indicative of a second orientation of the device relative to a user of the device;
computer program code for analyzing the first input and the second input to determine a change in orientation of the device relative to the user of the device; and
computer program code for adjusting orientation of a display presented to the user according to the determined change in orientation of the device relative to the user.

20. The computer program product of claim 19 wherein computer program code for analyzing the first input and the second input to determine a change in orientation of the device relative to the user of the device comprises:
computer program code for determining a first orientation of the device from the first input;
computer program code for determining a second orientation of the device relative to the user from the second input;
computer program code for comparing the first orientation of the device and the second orientation of the device relative to the user to determine differences between the first orientation of the device and the second orientation of the device relative to the user; and
computer program code for determining the change in orientation of the device relative to the user according to the differences between the first orientation of the device and the second orientation of the device relative to the user.
